(19) United States
(12) Patent Application Publication
(10) Pub. No.: US 2009/0199779 A1
(43) Pub. Date: Aug. 13, 2009

(54) LIGHTED AQUARIUM

(76) Inventor: Jerry L. Parks, Eaton Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/028,467

(22) Filed: Feb. 8, 2008

(51) Int. Cl. A01K 63/06; A01K 63/04; A01K 63/00

(52) U.S. Cl. 119/247; 119/248; 119/265; 119/255

(57) ABSTRACT

An aquarium includes a base, a tank on the base, a filter assembly in the tank, a bubble tube extending upward from the filter assembly, a light assembly under the tank and oriented to emit light upwardly through a bubble tube in the tank, a bubbler under the bubble tube, and a cover covering the tank including a window. The bubbler causes water to flow from the tank through the filter assembly and upward through the bubble tube back into the tank, with the light from the light assembly lighting bubbles floating upward through the bubble tube, a portion of the reflected light passing through the window. The light assembly includes multiple colored, light-emitting diodes and a controller for providing light patterns upward and also forward of the aquarium. The bubble tube acts as a light pipe and includes a front surface providing distinctive patterns of reflected light.

### BACKGROUND

The present invention relates to lighted aquariums.

Aquariums are intended to display fish and other water animals in attractive lighted arrangements. However, new and different aquariums are desired that further develop the ability to provide interesting light patterns and visually attractive arrangements. Further, it is desirable to provide an aquarium that can contribute functionally to the environment of the room it is in.

### SUMMARY OF THE PRESENT INVENTION

The present invention provides an uplighted aquarium where the lighted area provides extra-ordinarily attractive and novel light patterns using bottom-lighted aeration bubbles of the system. The arrangement further provides a water flow that keeps the uplighted area relatively clean, such that the arrangement can be used without the need for frequent maintenance. At the same time, the arrangement of components are well integrated and organized, such that assembly of components is quick and easy, the assembled unit is durable and long lasting, and the aesthetic presentation is maintained for a long time without continued messy and time consuming maintenance.

In one aspect of the present invention, an aquarium includes a tank with a clear bottom that is adapted to hold water. The tank also includes a top light for lighting fish and water life in the tank from above and a bottom light for emitting light upward through the tank and water and onto a room's ceiling above for acting as a night light.

In another aspect of the present invention, an aquarium includes a tank with a clear bottom that is adapted to hold water. At least one LED light is positioned under the tank for emitting light upward through the tank and water, the LED light providing visible light but minimal heat such that a temperature of the water is substantially not affected by heat from the LED light.

In another aspect of the present invention, an aquarium includes a tank with a clear bottom that is adapted to hold water. A cover covers the tank and that includes a window.

The tank also includes a bottom light for emitting light upward through the tank and water and window.

In another aspect of the present invention, an aquarium includes a tank with a clear bottom that is adapted to hold water. The tank also includes a plurality of bottom lights for emitting light upward through the tank and water, including at least two different colors of light, and a controller for selectively controlling the lights to emit the different colors so that a distinctive sequence of light patterns result.

In another aspect of the present invention, an aquarium includes a tank with a clear bottom that is adapted to hold water. A filter assembly is positioned in a bottom of the tank including an inlet for water to be cleaned and an outlet. A bubble tube is positioned near the outlet and extending upward. A bubbler is positioned near the outlet and near a bottom of the bubble tube such that the bubbler emits bubbles that float upward within the bubble tube to cause water to flow into the inlet and through the filter assembly and out the outlet into the bubble tube and upward back into a main portion of the tank. A bottom light is included for emitting light upward through the tank and water and through the bubble tube. The bubble tube has a forward-facing surface so that the bubbles, lighted by the bottom light, are visible from a front of the aquarium. The filter assembly in combination with the bubbler causes a water flow flowing upward from a bottom of the tank that keeps an area relatively clean where the bottom light shines through the bottom of the tank.

An object is to provide an uplighted aquarium where the uplight does not quickly become coated or covered with debris, fish food, and fish-generated debris.

An object is to provide an uplight aquarium with a distinctive light pattern not previously possible.

These and other aspects, objects, and features of the present invention will be understood and appreciated by those skilled in the art upon studying the following specification, claims, and appended drawings.

### BRIEF DESCRIPTION OF DRAWINGS

FIGS. 1-2 are exploded perspective and exploded side views of the aquarium.

FIG. 3 is a side cross-sectional view of the assembly of FIG. 1.

FIG. 4 is a cross-sectional view taken along line IV-IV in FIG. 3.

FIG. 5 is a partial view showing the LED light-emitting assembly, the window of the cover, and various light paths.

### DETAILED DESCRIPTION OF PREFERRED EMBODIMENTS

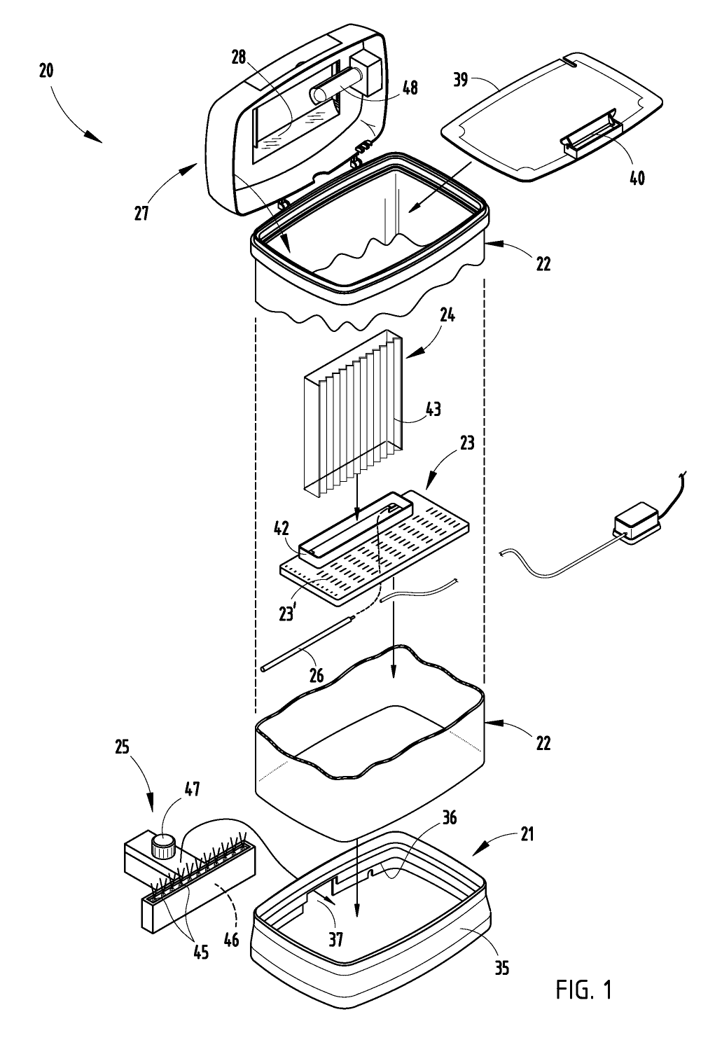

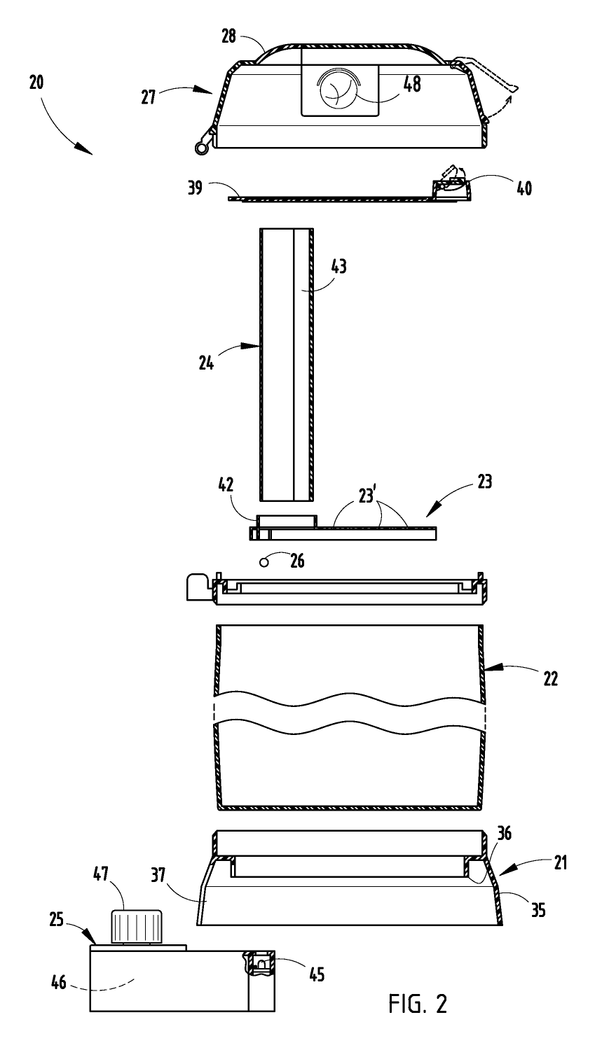

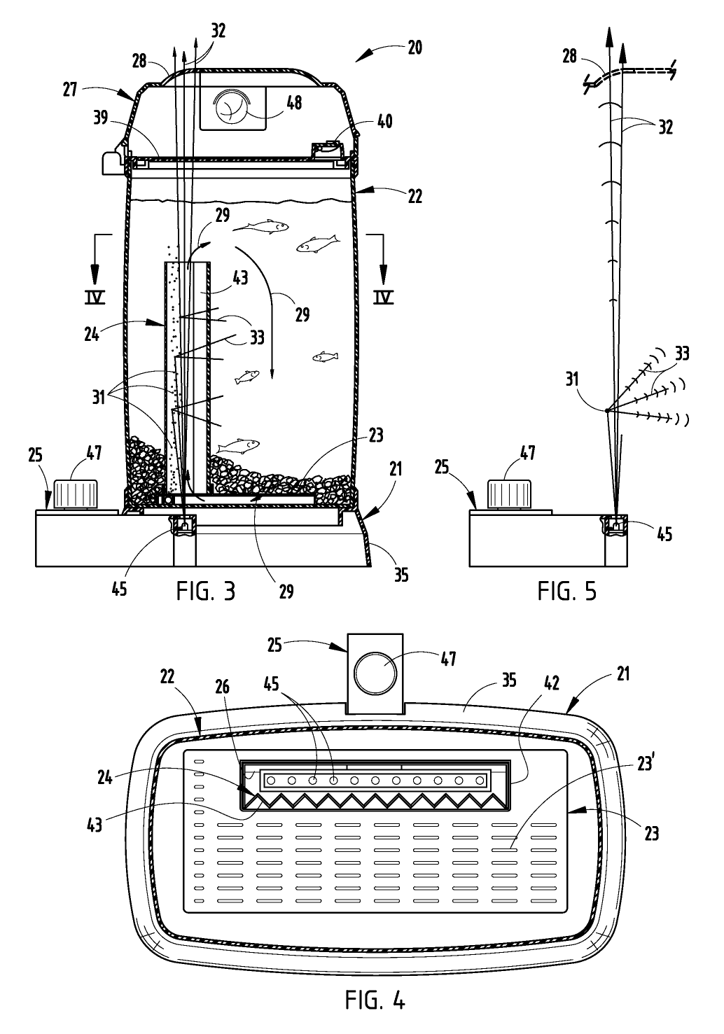

An aquarium 20 (FIGS. 1-4) includes a base 21, a clear tank 22 supported on the base 21, an under-gravel filter assembly 23 in a bottom of the tank 22, a bubble tube 24 extending upward from the filter assembly 23, a light assembly 25 with light-emitting diodes (LEDs) 45 oriented to emit light upwardly through the tank 22 and bubble tube 24, a bubbler 26 in a bottom of the bubble tube 24, and a cover 27 covering the tank 22 and including a window 28. The bubbler 26 is adapted to cause water to flow along a current 29 (FIG. 3) from the tank 22 into the filter assembly 23, out the filter assembly 23 and upward through the bubble tube 24 back into a top of the tank 22, with the light 30 from the light assembly 25 lighting bubbles 31 floating upward through the bubble tube 24, a portion 32 of the reflected light passing through the window 28 and a portion 33 reflected by the bubbles 31 forward through a front of the tube 24. A top light 48 provides traditional downlight onto the fish in the tank 22.

The illustrated base 21 includes an upwardly extending wall 35 forming a perimeter and includes an inwardly extending flange 36. An inner surface of the wall 35 combines with the flange 36 to form a pocket for stably receiving and supporting a bottom of the tank 22. A notch 37 is formed in a center of the rear wall 35 for receiving the light assembly 25, with an inward end of the light assembly 25 (i.e. that portion containing the LED's) positioned under the tank 22. The base 21 is opaque so that light is focused upwardly, and so that light is not passed around the base except as desired via the bulb 48. The light passes up the bubble tube 24 and is generally controlled by the surfaces of the bubble tube 24.

The tank 22 is configured to be stably supported on the base 21. The tank 22 is a clear container of generally rectangular configuration, including a relatively flat bottom, side walls. A top rim is formed on the tank 22 for engaging a clear generally-flat tank panel 39 to cover the tank 22 when the cover 27 is removed or pivoted to an open position. The panel 39 includes a small door 40 that can be opened to feed the fish in the tank 22.

A filter assembly 23 is adapted to be positioned in a bottom of the tank 22 under gravel or stone. The filter assembly 23 includes a rectangular housing with internal filter. The housing includes an apertured wall with an upwardly-facing water inlet slits on a front portion 23′, and an upwardly-facing water outlet on a rear portion. The outlet includes a rim 42 shaped to telescopingly receive the bubble tube 24. A bottom of the housing also includes flanges for retaining a bubbler 26 generally under the filter outlet. The illustrated filter assembly 23 is configured and designed to trap sediment and biological debris as water flows through the filter assembly, and biologically break the waste material down.

The bubble tube 24 fits into the rim 42 of the filter assembly 23 and extends upward from the filter assembly 23 about two-thirds (or more) of the tank's height. The bubble tube 24 is made of transparent material, and includes a flat rear wall, flat side walls, a configured front wall 43, an open top and an open bottom. The illustrated front wall 43 forms a zigzag or undulating shape which results in forward-traveling light being diffused or scattered in an attractive manner. It is contemplated that the front wall can include other shapes to diffuse light (e.g. dome-shapes, stippled patterns, etc.), or that the front surface can be left flat. The illustrated bubble tube 24 is reversible front to rear, such that the present bubble tube 24 can be arranged to provide different light patterns using a single set of components. Notably, the bubble tube 24 can be reversed by simply lifting the bubble tube 24 out of the receiving flanges 42 on the filter, reversing the bubble tube 24, and replacing the bubble tube 24 in its mating position in the flanges 42.

The light assembly 25 includes a series of colored LED's 45 oriented to emit light upwardly through a bottom of the tank 22 and upwardly through the bubble tube 24 to the window 28 on the cover 27. The assembly 25 further includes a controller 46 for controlling the pattern and sequence of powering the LEDs 45, and a control knob 47 for changing the controller 46 to different modes. There is also a light 48 attached to the cover 27 for shining light downwardly from a top of the tank 22 onto fish and water life therebelow. The light 48 shines light in a top down direction, which is important for viewing fish in the tank 22, and also for providing a traditional lighting pattern when desired. The light 48 can be an LED or incandescent bulb, but it is noted that where an LED light source is used, less heat is generated. Notably, the LED's 45 (and also LED 48) generate considerably less heat and further a position of the lower LED's 45 is spaced from a bottom of the tank such that minimal heat is passed upwardly into the water. This is important since both water temperature and minimization of temperature fluctuation is very important to health and longevity of the fish and aquatic life in the tank. Also, it is noted that some commercially available LEDs can provide different colors of light, and that the use of multi-color-generating-light-emitting diodes in combination with the present controller would provide a compact and attractive arrangement in the present inventive aquarium.

The bubbler 26 is horizontally elongated and positioned in a bottom of the bubble tube 24 to emit bubbles in the water that float upwardly in the bubble tube 24. This causes water to flow gently along a current 29 (FIG. 3) from the tank 22 into the filter assembly 23, out the filter assembly 23 and upward through the bubble tube 24 back into a top of the tank 22. This clean water current is upward from the LEDs 45, tending to keep the LEDs 45 and the associated area much cleaner, such that very little (or zero) debris and “junk” come to rest and cover the LEDs 45 over time. The LEDs 45 light the bubbles 31 floating upward through the bubble tube 24, and a portion 32 of the reflected light passes through the window 28. Sufficient light passes upward out window 28 such that the present arrangement acts as a night light for the room in which it is positioned. Light from the LEDs 45 also reflects off bubbles 31 in different directions. A portion of the reflected light travels forward through the front wall of the bubble tube 24. This creates an interesting and changing pattern on the aquarium tank's front wall. A portion of the reflected light also travels out of the tank 22, creating an interesting pattern in an area in front of the aquarium.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. An aquarium comprising:
a base;
a tank supported on the base;
a filter assembly in a bottom of the tank;
a bubble tube extending upward from the filter assembly;
a light assembly oriented to emit light upwardly through the tank and bubble tube;
a bubbler in a bottom of the bubble tube; and
a cover covering the tank and including a window;
the bubbler being adapted to cause water to flow from a main portion of the tank into the filter assembly, out the filter assembly and upward through the bubble tube back into the main portion of the tank, with the light from the light assembly lighting bubbles floating upward through the bubble tube, a portion of the reflected light passing through the window.

2. The aquarium defined in claim 1, wherein the base is opaque and contains the light assembly such that the base directs light primarily upwardly from the light assembly.

3. The aquarium defined in claim 2, wherein the base includes a notch, and the light assembly includes a housing that matably engages the notch.

4. The aquarium defined in claim 3, wherein the base includes first flanges supporting the tank in an elevated position, and includes second flanges that support the light assembly under the tank.

5. The aquarium defined in claim 1, wherein the bubble tube releasably engages a rim on the filter assembly, and is reversible.

6. The aquarium defined in claim 1, wherein the bubble tube is transparent and includes a first surface that is relatively flat for passing light undisturbed in generally a horizontal direction, and a second surface that is undulated for passing light in a scattered but generally horizontal direction.

7. The aquarium defined in claim 1, wherein the bubbler is elongated and positioned generally in a horizontal direction when mounted to the base.

8. The aquarium defined in claim 1, wherein the light assembly includes at least one light-emitting diode.

9. The aquarium defined in claim 8, wherein the at least one light-emitting diode includes a plurality of light-emitting diodes.

10. The aquarium defined in claim 9, wherein the light-emitting diodes include colored-light-emitting diodes.

11. The aquarium defined in claim 10, including a controller for controlling the diodes to cause a particular pattern of light to be emitted.

12. An aquarium comprising:
a tank with a clear bottom that is adapted to hold water;
a top light for lighting fish and water life in the tank from above; and
a bottom light for emitting light upward through the tank and water and onto a room's ceiling above for acting as a night light.

13. The aquarium defined in claim 12, wherein the bottom light includes at least one light-emitting diode.

14. The aquarium defined in claim 13, wherein the bottom light includes a plurality of light-emitting diodes with at least some of the diodes being capable of generating colored light.

15. The aquarium defined in claim 12, wherein the bottom light is spaced from and positioned under a bottom of the tank.

16. An aquarium comprising:
a tank with a clear bottom that is adapted to hold water;
at least one light-emitting diode positioned under the tank for emitting light upward through the tank and water, the light-emitting diode light providing visible light but minimal heat such that a temperature of the water is substantially not affected by heat from the light-emitting diode.

17. The aquarium defined in claim 16, wherein the at least one light-emitting diode includes a plurality of light-emitting diodes.

18. The aquarium defined in claim 17, wherein the light-emitting diodes include colored-light-emitting diodes.

19. The aquarium defined in claim 18, including a controller for controlling the diodes to cause a particular pattern of light to be emitted.

20. An aquarium comprising:
a tank with a clear bottom that is adapted to hold water;
a cover covering the tank and that includes a window;
a bottom light for emitting light upward through the tank and water and window.

21. The aquarium defined in claim 20, wherein the bottom light includes a plurality of light-emitting diodes.

22. The aquarium defined in claim 21, wherein the light-emitting diodes include colored-light-emitting diodes.

23. The aquarium defined in claim 22, including a controller for controlling the diodes to cause a particular pattern of light to be emitted.

24. The aquarium defined in claim 20, including a light tube positioned in the tank over the bottom light for communicating light upwardly through the tank, the light tube being horizontally elongated and including a front surface for also passing light forwardly.

25. An aquarium comprising:
a tank with a clear bottom that is adapted to hold water;
a plurality of bottom lights for emitting light upward through the tank and water, including at least two different colors of light;
a controller for selectively controlling the lights to emit the different colors so that a distinctive sequence of light patterns result.

26. The aquarium defined in claim 25, including an opaque base for supporting the tank in an elevated position and for positioning the bottom lights under the bottom of the tank.

27. The aquarium defined in claim 26, including a light assembly having a frame that supports the bottom lights under the tank, the frame matably engaging the base for positioning the bottom lights.

28. An aquarium comprising:
a tank with a clear bottom that is adapted to hold water;
a filter assembly positioned in a bottom of the tank including an inlet for water to be cleaned and an outlet;
a bubble tube positioned near the outlet and extending upward;
a bubbler positioned near the outlet and near a bottom of the bubble tube such that the bubbler emits bubbles that float upward within the bubble tube to cause water to flow into the inlet and through the filter assembly and out the outlet into the bubble tube and upward back into a main portion of the tank;
a bottom light for emitting light upward through the tank and water and through the bubble tube; the bubble tube having a forward-facing surface so that the bubbles, lighted by the bottom light, are visible from a front of the aquarium; the filter assembly in combination with the bubbler causing a water flow flowing upward from a bottom of the tank and keeping an area relatively clean where the bottom light shines through the bottom of the tank.
